(19) United States
(12) Patent Application Publication
(10) Pub. No.: US 2008/0096064 A1
(43) Pub. Date: Apr. 24, 2008

(54) Current: A Total Energy Management System

(76) Inventor: David Alfred Elia, Clarence, NY (US)

Correspondence Address: David A. Elia, 4950 Strickler Rd, PO Box 658, Clarence, NY, 14031-0658, US

(21) Appl. No.: 11/551,258

(22) Filed: Oct. 20, 2006

(51) Int. Cl. H01M 8/18; F02B 43/00; F02C 3/04

(52) U.S. Cl. 429/21; 123/1 A; 60/805

(57) ABSTRACT

The invention is a complete energy management system that utilizes renewable energy to generate electricity, makes hydrogen via electrolysis and then utilizes hydrogen to generate electricity on demand.

### BACKGROUND OF INVENTION

Skyrocketing fuel prices and concerns about global warming indicate that reconsideration of current energy policy is warranted. Although intense interest in the topic exists, most of the attention appears focused solely on finding alternative energy resources to generate electricity. While this is surely an important effort, it is an incomplete strategy since it merely addresses one aspect of the energy problem: supply. It is inadequate for tackling the total predicament because it does not address other important factors inherent in the problem: the inability to either control demand or store electricity. By perceiving it in this more systemic way, the energy (and environmental) problem is framed as: the utilization of polluting energy resources in a manner insufficient to meet energy demand. Thus viewed, the solution appears simple: utilize “green” non-polluting energy resources in a manner that meets demand. The invention is a method to achieve said solution.

### DETAILED DESCRIPTION

The invention is a method and process for generating electricity, converting electricity to hydrogen, storing hydrogen and converting hydrogen back to electricity when needed. The invention is the total system that includes a renewable energy source, means to produce and store hydrogen, means to produce electricity from stored hydrogen in conjunction with computer-aided devices designed to seamlessly supply electricity to local power grids only when electrical demand exceeds supply and produce hydrogen when electrical supply exceeds demand. Electricity is first produced from any number of renewable energy resource processes known in the prior art. These processes include, but are not limited to: hydroturbines (the preferred embodiment), wind turbines and solar panels. Electricity thus produced is transformed by a power conditioner, controlled by computer-aided switches and other devices known in the prior art before connection to an electrical grid. Utilizing electrical load sensing devices, computer-aided switches and other control devices known in the prior art, electricity from the grid is drawn to power electrolysizers, also known in the industry. Thus controlled, the electrolysizers are used to produce hydrogen only at such times as there exists a surplus of electricity available on the grid. The hydrogen thus produced is stored in tanks as a compressed gas or liquid. Utilizing electrical load sensing devices, computer-aided switches, other control devices and pumps, all known in the prior art, stored hydrogen is used as fuel to generate supplemental electricity via internal combustion engines, gas turbines, sterling engines, expansion engines or fuel cells only at such times as there exists a deficit of electricity available on the grid. In this manner, the invention balances electrical supply with electrical demand and generates hydrogen (and oxygen as a byproduct) for use as fuel with surpluses available for other uses, all without any adverse environmental impact.

What is claimed is:

1. An energy management process comprising:
means for generating electricity;
means to convert electricity into hydrogen;
means to store hydrogen; and,
means to convert hydrogen into electricity.

2. The method of claim 1 wherein said first generation of electricity is by hydroturbine.

3. The method of claim 1 wherein said first generation of electricity is by wind turbine.

4. The method of claim 1 wherein said first generation of electricity is by photo voltaic means.

5. The method of claim 1 wherein said conversion of electricity into hydrogen is by electrolysis.

6. The method of claim 1 wherein said storage of hydrogen is by containment as a compressed gas in an enclosed vessel.

7. The method of claim 1 wherein said storage of hydrogen is by containment as a refrigerated liquid in an enclosed vessel.

8. The method of claim 1 wherein said converting hydrogen back into electricity is by internal combustion engine.

9. The method of claim 1 wherein said converting hydrogen back into electricity is by fuel cell.

10. The method of claim 1 wherein said converting hydrogen back into electricity is by gas turbine.

11. The method of claim 1 wherein said converting hydrogen back into electricity is by sterling engine.

12. The method of claim 1 wherein said converting hydrogen back into electricity is by expansion engine.

13. The method of claim 8 further comprising the step of controlling electricity thus produced by means of power conditioners, load sensing devices, computers, software, computer-aided switches and other control devices known in the prior art in a manner and sequence so that electricity is produced for transmission onto the local grid only when electrical demand exceeds electricity supplied by other methods.

14. The method of claim 9 further comprising the step of controlling electricity thus produced by means of power conditioners, load sensing devices, computers, software, computer-aided switches and other control devices known in the prior art in a manner and sequence so that electricity is produced for transmission onto the local grid only when electrical demand exceeds electricity supplied by other methods.

15. The method of claim 10 further comprising the step of controlling electricity thus produced by means of power conditioners, load sensing devices, computers, software, computer-aided switches and other control devices known in the prior art in a manner and sequence so that electricity is produced for transmission onto the local grid only when electrical demand exceeds electricity supplied by other methods.

16. The method of claim 11 further comprising the step of controlling electricity thus produced by means of power conditioners, load sensing devices, computers, software, computer-aided switches and other control devices known in the prior art in a manner and sequence so that electricity is produced for transmission onto the local grid only when electrical demand exceeds electricity supplied by other methods.

17. The method of claim 12 further comprising the step of controlling electricity thus produced by means of power conditioners, load sensing devices, computers, software, computer-aided switches and other control devices known in the prior art in a manner and sequence so that electricity is produced for transmission onto the local grid only when electrical demand exceeds electricity supplied by other methods.
